(19) United States
(12) Patent Application Publication
(10) Pub. No.: US 2007/0044596 A1
(43) Pub. Date: Mar. 1, 2007

(54) Bit connector

(76) Inventor: Chang-Ying Chen, Ta Li City (TW)

Correspondence Address: PHILLIP LIU, 6980, WHITEOAK DR., RICHMOND, BC, V7EAZ9, CA

(21) Appl. No.: 11/208,712

(22) Filed: Aug. 23, 2005

(51) Int. Cl. B25B 13/02; B25B 23/00

(52) U.S. Cl. 81/125; 81/438

(57) ABSTRACT

A bit connector includes a cylindrical body which has a polygonal recess for receiving a screw bit therein and a passage is defined radially through a wall of the body and communicates with the polygonal recess. A flexible G-shaped positioning member is mounted to the body and includes an insertion which extends inward and is inserted into the passage. A distal end of the insertion is removably inserted into the polygonal recess so as to be engaged with another groove defined in an outer periphery of the screw bit. The insertion can be pushed outward when the screw bit is inserted into or removed from the polygonal recess.

### FIELD OF THE INVENTION

The present invention relates to a bit connector with a G-shaped member mounted thereto and a bending end of the G-shaped member is inserted in the receiving hole to be engaged with a groove of the bit.

### BACKGROUND OF THE INVENTION

A conventional bit connector generally includes a cylindrical member with a polygonal hole defined in an end thereof and the screw bit has a polygonal shank which can be removably engaged with the polygonal hole of the connector. The inner periphery of the polygonal hole can be made slightly smaller than the polygonal shank so that the screw bit can be positioned in the polygonal hole of the connector. When the users wants to remove the screw bit from the connector, he or she has to hold the connector by one hand and the other hand pulls the screw bit away from the connector. In order to firmly position the screw bit, a collar is engaged with the inner periphery of the polygonal hole so that the shank of the screw bit can be securely enclosed by the collar. However, it is difficult to install the collar into the polygonal hole.

The present invention intends to provide a bit connector which has a G-shaped member mounted thereto and a bending end of the G-shaped member is radially inserted into the connector and communicates with the polygonal hole and can be engaged with a groove defined in the shank of the screw bit. The bending end of the G-shaped member includes a proper spring force such that that the screw bit can be well positioned and can be easily removed from the polygonal hole of the connector.

### SUMMARY OF THE INVENTION

The present invention relates to a bit connector which comprises a body having a polygonal recess in a first end thereof so as to receive a screw bit, a passage is defined radially through a wall of the body and communicates with the polygonal recess. A flexible positioning member is mounted to the body and has an insertion which extends inward and is inserted into the passage. A distal end of the insertion is removably inserted into the polygonal recess so as to be engaged with a groove defined in an outer periphery of the screw bit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the body and the positioning member of the bit connector of the present invention;

FIG. 2 shows that the bit connector is made with a screw driver and a screw bit is to be connected to the bit connector;

FIGS. 3 and 4 show two respective cross sectional views of the insertion of the screw bit to be inserted into the bit connector;

FIG. 5 is an enlarged cross sectional view to show the distal end of the insertion of the positioning member extended into the polygonal recess of the bit connector;

FIG. 6 is a top view of the bit connector in FIG. 5;

FIG. 7 is an enlarged cross sectional view to show that the screw bit is inserting into the polygonal recess of the bit connector;

FIG. 8 is a top cross sectional view to show that the shank of the screw bit is inserting into the polygonal recess of the bit connector;

FIG. 9 is an enlarged cross sectional view to show that the screw bit is inserted into the polygonal recess of the bit connector and the distal end of the insertion of the positioning member is engaged with the groove in the screw bit, and

FIG. 10 is a top cross sectional view of FIG. 9.

### DETAILED DESCRIPTION OF THE PREFERRED EMBODIMENT

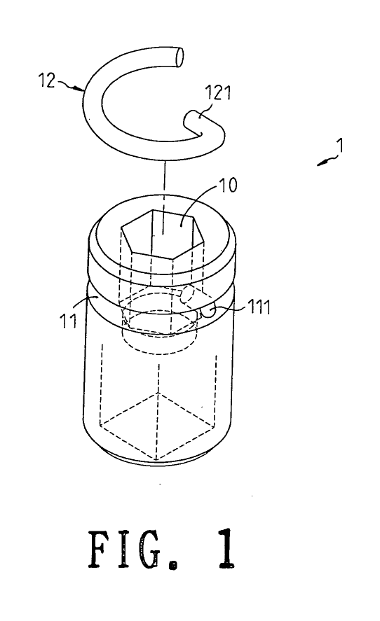

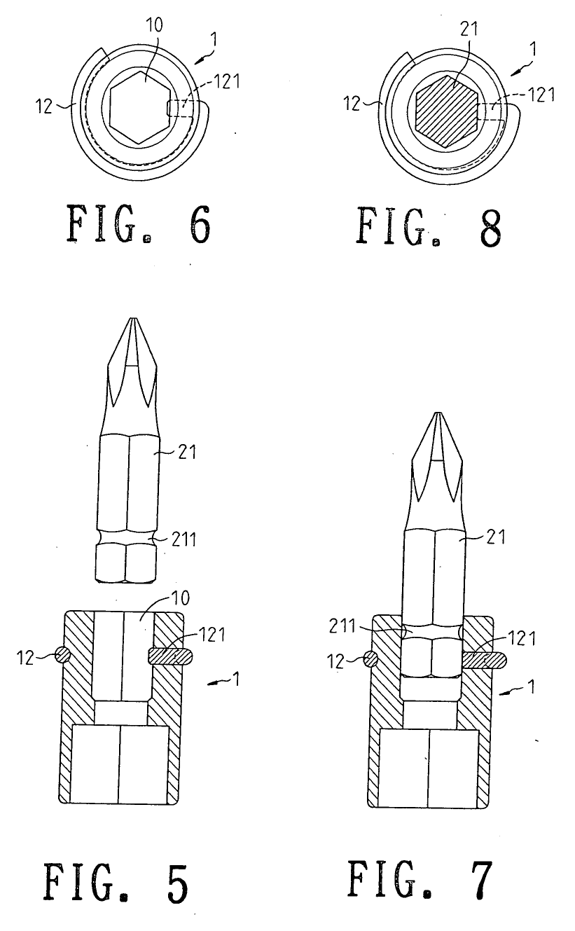

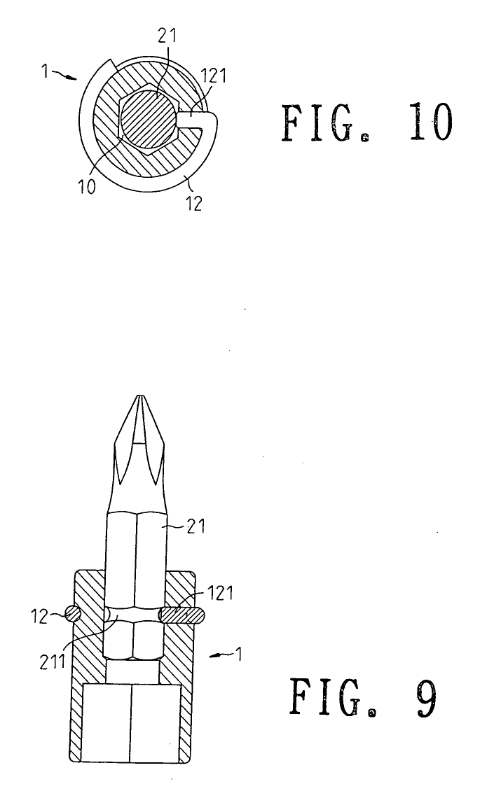

Referring to FIGS. 1 and 5-10, the bit connector of the present invention comprises a cylindrical body 1 having a polygonal recess 10 defined in a first end thereof and a polygonal hole is defined in a second end of the body 1. The polygonal recess 10 may accommodate a screw bit 21 and the polygonal hole in the second end of the body 1 is to be connected with a tool so that the body 1 can be rotated. A passage 111 is defined radially through a wall of the body 1 and communicates with the polygonal recess 10. A groove 11 is defined in an outer periphery of the body 1.

A flexible positioning member 12 which is a G-shaped member in this embodiment, the positioning member 12 is mounted to the body 1 and engaged with the groove 11 of the body 1. The flexible positioning member 12 has an insertion 121 which is an end bending inward and is inserted into the passage 111. A distal end of the insertion 121 is removably inserted into the polygonal recess 10. The flexible positioning member 12 can also be a flexible loop with an insertion extending inward therefrom.

The screw bit 21 includes a shank and another groove 211 is defined in an outer periphery thereof. The shank can be inserted into the polygonal recess 10 of the body 1 and the distal end of the insertion 121 is pushed outward until the distal end of the insertion 121 is engaged with the groove 211 of the screw bit 21. When removing the bit 21 from the bit connector, simply pulling the bit 21 out and the distal end of the insertion 121 can also be pushed outward by the shank of the bit 21. The flexible positioning member 12 is mounted to the body 1 so that it is easy to combine the flexible positioning member 12 to the body 1.

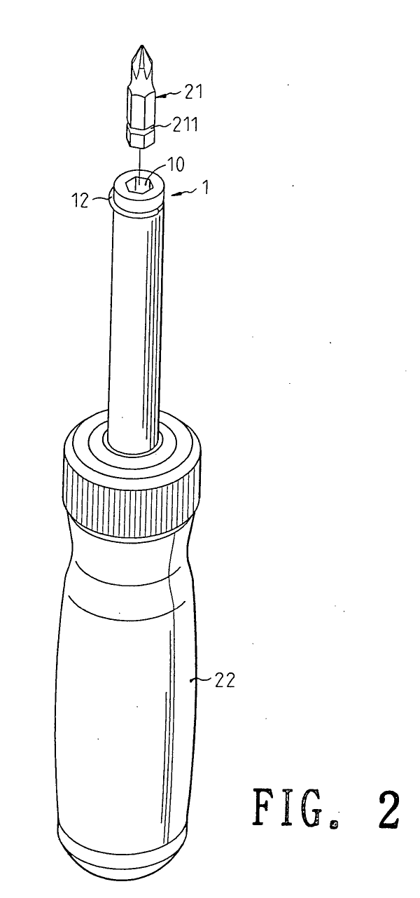

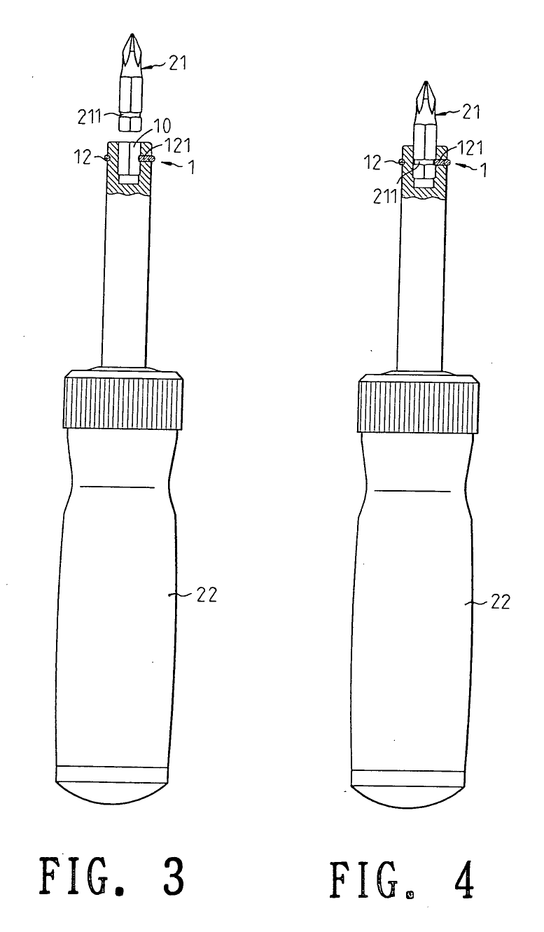

Referring to FIGS. 2 to 4, another embodiment of the present invention is that the second end of the body 1 is a shank of a hand tool which has a handle 22 so that the user can easily rotate the screw bit 21 by operating the handle 22.

While we have shown and described the embodiment in accordance with the present invention, it should be clear to those skilled in the art that further embodiments may be made without departing from the scope of the present invention.

What is claimed is:

1. A bit connector comprising:
a body having a polygonal recess defined in a first end thereof, a passage defined radially through a wall of the body and communicating with the polygonal recess, and
a flexible positioning member mounted to the body and having an insertion which extends inward and is inserted into the passage, a distal end of the insertion removably inserted into the polygonal recess.

2. The bit connector as claimed in claim 1, wherein the flexible positioning member is a G-shaped member and the insertion is an end bending inward.

3. The bit connector as claimed in claim 1, wherein a groove is defined in an outer periphery of the body and the positioning member is engaged with the groove.

4. The bit connector as claimed in claim 1, wherein a polygonal hole is defined in a second end of the body.

5. The bit connector as claimed in claim 1, a handle is connected to a second end of the body.
